(19) United States
(12) Patent Application Publication
(10) Pub. No.: US 2009/0019384 A1
(43) Pub. Date: Jan. 15, 2009

(54) Display method and management module for image before entering operating system

(75) Inventor: Chih-Sheng Chien, Taipei (TW)

Correspondence Address: J C PATENTS, INC., 4 VENTURE, SUITE 250, IRVINE, CA, 92618, US

(73) Assignee: ASUSTeK COMPUTER INC., Taipei (TW)

(21) Appl. No.: 12/217,991

(22) Filed: Jul. 9, 2008

(30) Foreign Application Priority Data
Jul. 11, 2007 (TW) 96125241

(51) Int. Cl. G06F 3/048

(52) U.S. Cl. 715/764

(57) ABSTRACT

A display method and a management module for an image before entering an operating system are disclosed and can be applied to a computer device. The display method includes the following steps. First, an original information image is provided. Then, a background image is provided. Finally, the original information image and the background image are mixed according to a transparency value to obtain a new information image.

### CROSS-REFERENCE TO RELATED APPLICATION

This application claims the priority benefit of Taiwan application serial no. 96125241, filed on Jul. 11, 2007. The entirety of the above-mentioned patent application is hereby incorporated by reference herein and made a part of specification.

### BACKGROUND OF THE INVENTION

1. Field of the Invention

The invention relates to the technology field of a basic input output system (BIOS) and, more particularly, to a display method and a management module for an image before entering an operating system.

2. Description of the Related Art

In the configuration of a computer system, a basic input output system (BIOS) is basic software for basic operation of the computer system. The BIOS is mostly composed of a series of low level instruction sets and is in charge of, for example, testing basic hardware during the operation of the computer system, defining features of the computer system and processing basic work. For example, during the booting process of the computer, the BIOS can detect or set the peripheral hardware devices such as a hard disk, a keyboard and a connection port.

In the conventional technology, when a computer system is booted to execute the BIOS, displayed booting images mostly are the same. Taking a conventional computer host as an example, during the booting process of the computer, the BIOS detects or sets different devices on a motherboard, and this action is called power on self test (POST) for short. During the POST process, the BIOS enables some word information to be displayed on the booting image to notify a user of the detection state of the present hardware devices; when a hardware device is abnormal, the BIOS notifies the user of the error state. In the conventional computer, the booting image is only used to display information, and therefore, it is unchangeable and lacks sense of beauty.

In recent years, to increase the sense of beauty of the booting image, the display content of the booting image changes from the original word information to a drawing. Although users who want to see the word information can make the word information redisplayed via BIOS options, the two displaying modes cannot be used simultaneously, and beauty and function are not both considered.

### BRIEF SUMMARY OF THE INVENTION

The invention provides a display method for an image before entering an operating system. The display method can display an original information image, a background image or both of them according to the setting of a user.

The invention further provides a display method for an image before entering an operating system, and the display method can be applied to a computer device. The display method includes the step of providing an original information image and a background image. In the invention, the original information image and the background image are mixed according to a transparency value to get a new information image.

The invention further provides a management module for an image before entering an operating system, and the management module can be applied to the basic input output system (BIOS) of a computer device. The management module provided by the invention includes a core unit, an analysis unit and a calculating unit. The core unit is used for executing a booting program before the computer device enters the operating system, and then the core unit outputs an original information image. Next, the analysis unit receives the original information image and a background image and analyzes color gamut distribution of the original information image and the background image. The calculating unit is coupled to the output of the analysis unit, and it mixes the original information image and the background image according to a transparency value to output a new information image for the computer device to display.

In the display method for an image before entering an operating system provided by the invention, the color gamut distribution of the original information image and the background image is computed via a transparency algorithm to obtain a new information image which can show the original information image, the background image or both of them. In this way, sense of beauty and information of the power on self test are both obtained.

These and other features, aspects, and advantages of the present invention will become better understood with regard to the following description, appended claims, and accompanying drawings.

### BRIEF DESCRIPTION OF THE SEVERAL VIEWS OF THE DRAWINGS

FIG. 1 is a flow chart showing a display method for an image before entering an operating system according to one embodiment of the invention.

FIG. 2 is a schematic diagram showing a new information image displayed by the display device of a computer when the transparency value is set to be 0%.

FIG. 3 is a schematic diagram showing a new information image displayed by the display device of a computer when the transparency value is set to be 25%.

FIG. 4 is a schematic diagram showing a new information image displayed by the display device of a computer when the transparency value is set to be 50%.

FIG. 5 is a schematic diagram showing a new information image displayed by the display device of a computer when the transparency value is set to be 75%.

FIG. 6 is a schematic diagram showing a new information image displayed by the display device of a computer when the transparency value is set to be 100%.

FIG. 7 is a flow chart showing a method for setting the transparency value according to the input of a user in one embodiment of the invention.

FIG. 8 is block diagram showing a management module for an image before entering an operating system according to one embodiment of the invention.

### DETAILED DESCRIPTION OF THE EMBODIMENTS

Embodiments of the invention are illustrated in detail with accompanying drawings hereinbelow. In the drawings, the same or similar reference numbers stand for the same or similar elements. The content in the drawings are simplified and are not drawn with a precise ratio.

The following disclosed technology is described to be proper and clear. For example, sequence relationships among steps and coupling relationships among units are only used to stand for the accompanying drawings. Persons having ordinary skills in the related art should know that the sequence and coupling relationships cannot be used to limit the spirit of the invention.

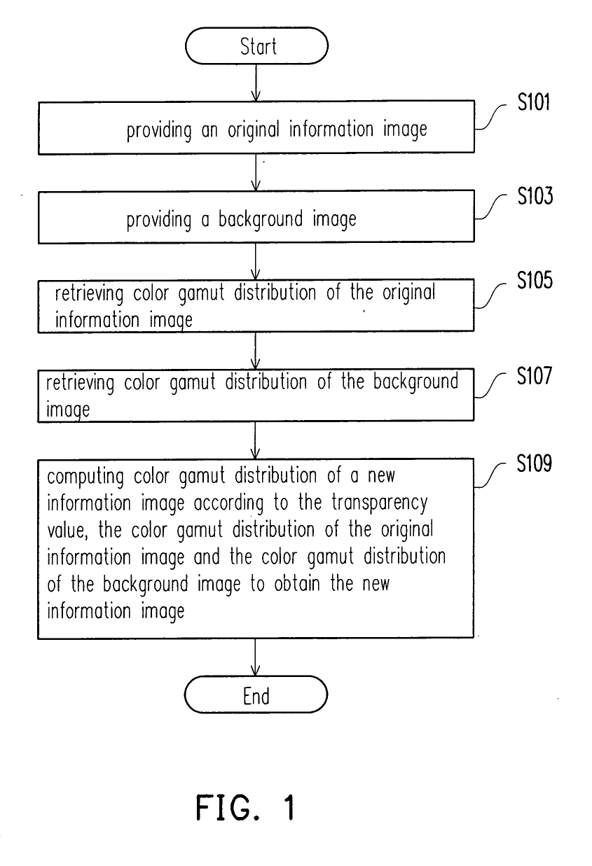

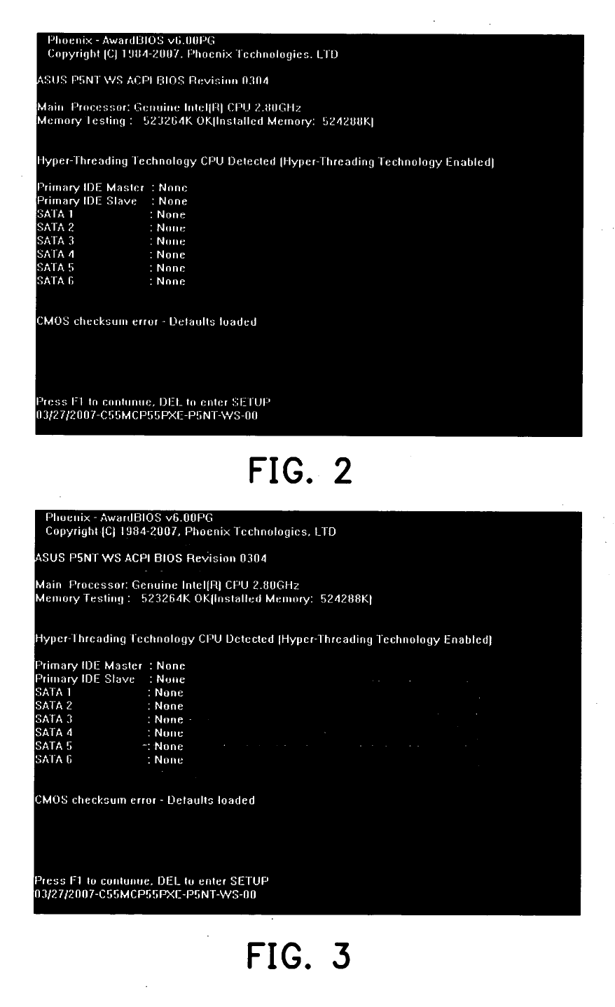

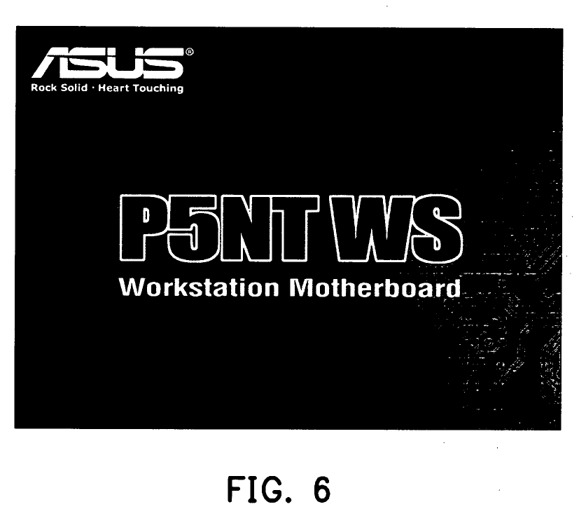

FIG. 1 is a flow chart showing a display method for an image before entering an operating system according to one embodiment of the invention. As shown in FIG. 1, in the embodiment, an original information image is provided as shown in the step S101. Generally speaking, the original information image can display the information of the power on self test (POST) or the setting image of the basic input output system (BIOS) when a computer is booted, and the information are displayed by words. The image shown in FIG. 2 is taken as an example. In the embodiment of the invention, a background image can also be provided as shown in the step S103. The background image can be a drawing set by a user. The image shown in FIG. 6 is taken as an example. In some embodiments, the background image and the original information image can be bitmap files.

In the embodiment, the color gamut distribution of the original information image can further be retrieved as shown in the step S105, and the color gamut distribution of the background image can also be retrieved as shown in the step S107. In this way, in the embodiment, the color gamut distribution of a new information image can be computed out via a transparency algorithm with a predetermined transparency value, the color gamut distribution of the original information image and the background image, and then the new information image is obtained as shown in the step S109.

In the embodiment, the transparency algorithm in the step S109 may be expressed as follows:

R3=R1*(1−T %)+R2*T %;

G3=G1*(1−T %)+G2*T %;

B3=B1*(1−T %)+B2*T %;

wherein (R3, G3, B3) are distribution values of the color gamut of the new information image, (R2, G2, B2) are distribution values of the color gamut of the background image, (R1, G1, B1) are distribution values of the color gamut of the original information image, and T stands for the transparency value.

From the above algorithm, different information images can be obtained via different transparency values T in the embodiment. FIG. 2 to FIG. 6 are schematic diagrams showing obtained new information images according to different transparency values in one embodiment of the invention.

FIG. 2 is a schematic diagram showing a new information image displayed by the display device of a computer when the transparency value is set to be 0%. The new information image may be the original information image.

FIG. 3 is a schematic diagram showing a new information image displayed by the display device of a computer when the transparency value is set to be 25%. As shown in FIG. 3, the hue of the word information of the original information image is darker, while the hue of the background image is lighter. In fact, along with the increase of the transparency value, the background image is more obvious and the original information image is vaguer.

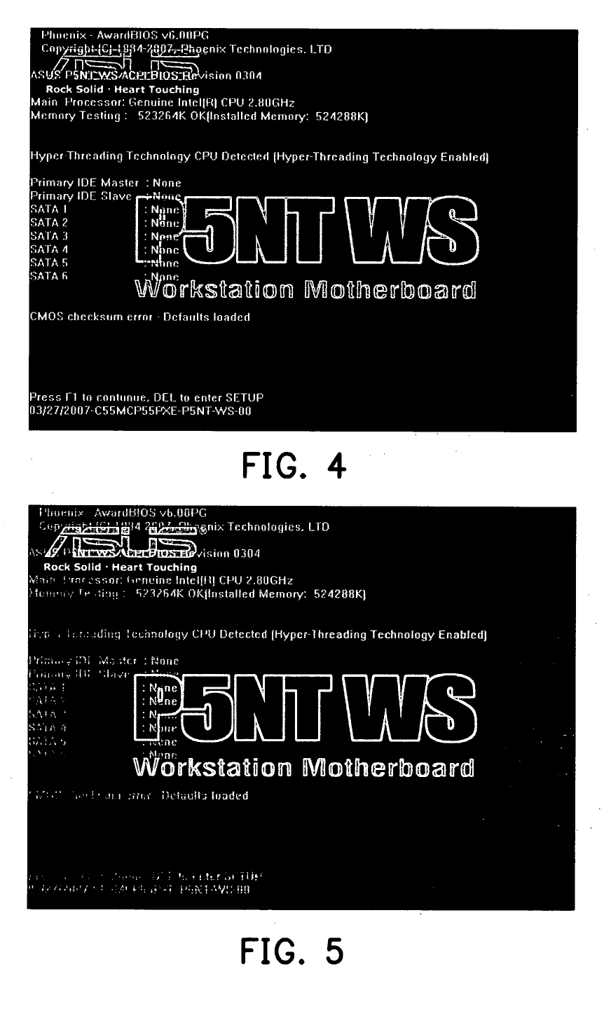

FIG. 4 is a schematic diagram showing a new information image displayed by the display device of a computer when the transparency value is set to be 50%. The set transparency value in FIG. 4 may be regarded as a default transparency value of the system.

FIG. 5 is a schematic diagram showing a new information image displayed by the display device of a computer when the transparency value is set to be 75%. As shown in FIG. 5, the hue of the word information of the original information image is darker than the hue of the drawing of the background image.

FIG. 6 is a schematic diagram showing a new information image displayed by the display device of a computer when the transparency value is set to be 100%. The new information image can be the background image. In FIG. 6, the word information of the original information image cannot be seen, and only the drawing of the background image set by a user can be seen.

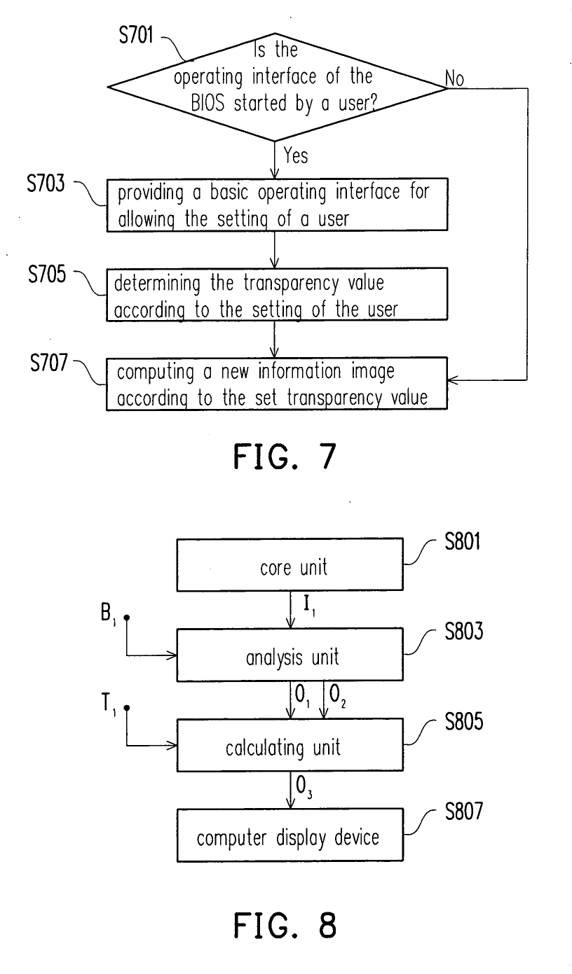

FIG. 7 is a flow chart showing steps of setting the transparency value in one embodiment of the invention. In the embodiment, whether a user starts the operating interface of the system can also be detected. In the embodiment, the detection method is to detect whether a user presses a key such as the F8 key for starting the basic operating interface in the keyboard. If the user does not start the operating interface (“no” in the step S701), the method of the embodiment directly enters the step S707 which is the step of computing a new information image according to a predetermined transparency value.

If the user wants to set the transparency value by himself, he can start the operating interface of the system (“yes” in the step S701), and then in the embodiment, as shown in the step S703, a basic operating interface is provided for the user to set the transparency value. The basic operating interface may be the operating interface of a basic input output system (BIOS).

Afterwards, in the embodiment, the transparency value can be determined according to the input of the user and stored in the computer system (the step S705), and then the step S707 can be executed. That is, the step of calculating a new information image according to the set transparency value can be executed.

FIG. 8 is block diagram showing a management module for an image before entering an operating system according to one embodiment of the invention. As shown in FIG. 8, the management module in the embodiment at least includes a core unit 801, an analysis unit 803, a calculating unit 805 and a computer display device 807.

The core unit 801 is coupled to the analysis unit 803, and the core unit 801 outputs an original information image I₁ to the analysis unit 803. The analysis unit 803 is coupled to the calculating unit 805, and the analysis unit 803 receives the original information image I₁ and a background image B₁. Next, the analysis unit 803 retrieves the color gamut distribution of the received original information image I₁ and the received background image B₁, respectively, and outputs output signals O₁ and O₂ to the calculating unit 805, respectively. The output signal O₁ is the color gamut distribution of the original information image I₁, and the output signal O₂ is the color gamut distribution of the background image B₁.

The calculating unit 805 is coupled to the computer display device 807, and the calculating unit 805 receives the output signal O₁, the output signal O₂ and a transparency value T₁. Afterwards, the calculating unit 805 mixes the received output signals O₁ and O₂ according to the transparency value T₁ to obtain an output signal O₃ and outputs the output signal O₃ to the computer display device 807. After the computer display device 807 receives the output signal O₃, the computer display device 807 displays a new information image for a user.

In the embodiment, the core unit 801 can be realized by a core program of the BIOS and is used for executing a booting program before the computer device enters the operating system. The booting program may be the power on self test program of the computer device or the setting program of the BIOS.

The display method and the management module for an image before entering an operating system are illustrated hereinbefore, and the chief feature of the method and the module is that a transparency value is provided, the color gamut distribution of the original information image and the color gamut distribution of the background image are mixed according to the transparency value, and a new information image is outputted. Therefore, the new information image displayed on the computer device can consider both sense of beauty and the objective of displaying information of the power on self test when the computer system is booted.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A display method for an image before entering an operating system, which is applied to a computer device, the display method comprising the steps of:
providing an original information image;
providing a background image; and
mixing the original information image and the background image to obtain a new information image according to a transparency value.

2. The display method according to claim 1, wherein the original information image is the power on self test (POST) image of the computer device.

3. The display method according to claim 1, wherein the original information image is a setting image of a basic input output system (BIOS) of the computer device.

4. The display method according to claim 1, wherein the original information image is used for displaying word information.

5. The display method according to claim 1, wherein the original information image and the background image are bitmap (BMP) files.

6. The display method according to claim 1, further comprising the steps of:
retrieving the color gamut distribution of the original information image;
retrieving the color gamut distribution of the background image; and
calculating the color gamut distribution of the new information image according to the transparency value, the color gamut distribution of the original information image and the color gamut distribution of the background image to obtain the new information image.

7. The display method according to claim 1, further comprising the steps of:
providing a basic operating interface for allowing a user to set; and
determining the transparency value according to the setting of the user.

8. The display method according to claim 7, wherein the basic operating interface is the setting image of the basic input output system (BIOS) of the computer device.

9. The display method according to claim 1, wherein the transparency value is between 0 and 1.

10. The display method according to claim 9, wherein when the transparency value is set to be 0, the new information image is the original information image.

11. The display method according to claim 9, wherein when the transparency value is set to be 1, the new information image is the background image.

12. A management module for an image before entering an operating system, which is applied to the basic input output system of a computer device, the management module comprising:
a core unit which is used for executing a booting program before the computer device enters the operating system and outputs an original information image;
an analysis unit which receives the original information image and a background image and analyzes color gamut distribution of the original information image and color gamut distribution of the background image; and
a calculating unit which is coupled to the analysis unit, mixes the original information image and the background image according to a transparency value, and outputs a new information image to be displayed on the computer device.

13. The management module according to claim 12, wherein the booting program is the power on self test (POST) program of the computer device.

14. The management module according to claim 12, wherein the booting program is the setting program of the BIOS.

15. The management module according to claim 12, wherein the transparency value is set by a user, and the transparency value is between 0 and 1.

16. The management module according to claim 15, wherein when the transparency value is set to be 0, the calculating unit outputs the original information image as the new information image.

17. The management module according to claim 15, wherein when the transparency value is set to be 1, the calculating unit outputs the background image as the new information image.
